(19) United States
(12) Patent Application Publication
(10) Pub. No.: US 2026/0023617 A1
(43) Pub. Date: Jan. 22, 2026

(54) OVERSUBSCRIPTION REINFORCEMENT LEARNER

(71) Applicant: Microsoft Technology Licensing, LLC, Redmond, WA (US)

(72) Inventors: Lu WANG, Beijing (CN); Mayukh DAS, Bengaluru (IN); Fangkai YANG, Beijing (CN); Hang DONG, Beijing (CN); Bo QIAO, Beijing (CN); Yudong LIU, Beijing (CN); Si QIN, Beijing (CN); Victor Jonas RUEHLE, Cambridge (GB); Chetan BANSAL, Seattle, WA (US); Qingwei LIN, Beijing (CN)

(73) Assignee: Microsoft Technology Licensing, LLC, Redmond, WA (US)

(21) Appl. No.: 18/993,509

(22) PCT Filed: Sep. 9, 2022
(86) PCT No.: PCT/CN2022/118166

§ 371 Date: Jan. 10, 2025

(51) Int. Cl. G06F 9/50; G06N 20/00

(52) U.S. Cl. CPC G06F 9/5044; G06N 20/00; G06F 2209/5019; G06F 2209/503

(57) ABSTRACT

A computing system including one or more processing devices that train an oversubscription reinforcement learner at least in part by receiving computing resource usage trajectories. At the oversubscription reinforcement learner, the training further includes generating prototypes based at least in part on the computing resource usage trajectories. The training further includes, based at least in part on the prototypes, generating an oversubscription rate. The training further includes outputting a prototype feedback query and/or an oversubscription rate feedback query. The training further includes receiving a prototype feedback input and/or an oversubscription rate feedback input. Based at least in part on the computing resource usage trajectories, the prototypes, and the prototype feedback input and/or the oversubscription rate feedback input, the training further includes computing an objective function value and training the oversubscription reinforcement learner based at least in part on the objective function value.

### BACKGROUND

The term “oversubscription” is used to characterize scenarios where a system offers more resources or services to users or entities than its available capacity, assuming not all users would simultaneously or fully utilize the allotted capacity. In cloud services, cloud providers frequently oversubscribe their computing resources in order to allow greater proportions of those computing resources to be utilized. Thus, oversubscription may allow cloud service providers to leverage unused capacity and more efficiently operate their data centers.

Designing an oversubscription policy presents challenges related to overshooting and undershooting predicted computing resource utilization rates. Once a system is oversubscribed, overloading as well as under-utilization may happen at any point. Forecasting the users' demand and utilization behaviors at correct granularity and cadence is frequently difficult. An aggressive oversubscription policy unfairly penalizes an uncertain number of users who cannot access the resources, a circumstance known as overloading. On the other hand, a conservative oversubscription policy may result in unused resources and capacity, leading to inefficient resource usage or wastage.

### SUMMARY

A computing system is provided, including one or more processing devices that, during a training phase, train an oversubscription reinforcement learner. Training the oversubscription reinforcement learner includes receiving a plurality of computing resource usage trajectories. Training the oversubscription reinforcement learner further includes, at the oversubscription reinforcement learner, generating a plurality of prototypes that encode respective prototype trajectories based at least in part on the plurality of computing resource usage trajectories. Training the oversubscription reinforcement learner further includes generating an oversubscription rate based at least in part on the plurality of prototypes. Training the oversubscription reinforcement learner further includes outputting, to a user interface, a prototype feedback query associated with a prototype of the plurality of prototypes, and/or outputting, to the user interface, an oversubscription rate feedback query that indicates the oversubscription rate. Training the oversubscription reinforcement learner further includes receiving a prototype feedback input via the user interface in response to outputting the prototype feedback query and/or receiving an oversubscription rate feedback input via the user interface in response to outputting the oversubscription rate feedback query. Based at least in part on the plurality of computing resource usage trajectories, the plurality of prototypes, and the prototype feedback input and/or the oversubscription rate feedback input, training the oversubscription reinforcement learner further includes computing an objective function value. The oversubscription reinforcement learner is trained based at least in part on the objective function value.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts a computing system that includes a plurality of nodes, according to one example embodiment.

FIG. 2 schematically shows a node at which a plurality of virtual machines are executed and at which oversubscription is performed, according to the example of FIG. 1.

FIG. 3 schematically shows the computing system when an oversubscription reinforcement learner is executed at one or more processing devices, according to the example of FIG. 1.

FIG. 4 schematically shows the oversubscription reinforcement learner in additional detail when an oversubscription rate is generated, according to the example of FIG. 3.

FIG. 5 schematically shows the oversubscription reinforcement learner when a prototype feedback input and an oversubscription rate feedback input are used to compute an objective function value, according to the example of FIG. 3.

FIG. 6 schematically shows the objective function of the oversubscription reinforcement learner, according to the example of FIG. 5.

FIG. 7 schematically shows the computation of a representative capacity term included in the objective function, according to the example of FIG. 6.

FIG. 8 schematically shows the computation of an interpretability term included in the objective function, according to the example of FIG. 6.

FIG. 9 schematically shows the computation of a diversity term included in the objective function, according to the example of FIG. 6.

FIG. 10 schematically shows the selection of a prototype for prototype feedback query generation, according to the example of FIG. 3.

FIG. 11 shows an example prototype feedback query that may be presented to a user at a graphical user interface, according to the example of FIG. 3.

FIG. 12 shows an example oversubscription rate feedback query that may be presented to a user at a graphical user interface, according to the example of FIG. 3.

FIG. 13A schematically shows processing of a merge input received as the prototype feedback input, according to the example of FIG. 5.

FIG. 13B schematically shows processing of a split input received as the prototype feedback input, according to the example of FIG. 5.

FIG. 14 schematically shows the computing system during an inferencing phase performed subsequently to the training phase, according to the example of FIG. 3.

FIG. 15A shows a flowchart of an example method for use with an oversubscription reinforcement learner executed at a computing system, according to the example of FIG. 1.

FIG. 15B shows additional steps of the method of FIG. 15A that may be performed in some examples during training of the oversubscription reinforcement learner.

FIG. 15C shows additional steps of the method that may be performed in examples in which a plurality of trajectory embedding vectors are generated as shown in FIG. 15B.

FIG. 15D shows additional steps of the method of FIG. 15A that may be performed to use imitation learning during training of the oversubscription reinforcement learner.

FIG. 15E shows additional steps of the method of FIG. 15A that may be performed during an inferencing phase.

FIG. 16 shows a schematic view of an example computing environment in which the computing system of FIG. 1 may be instantiated.

### DETAILED DESCRIPTION

The problem of generating an oversubscription policy is addressed by the systems and methods discussed herein. Using such systems and methods, an oversubscription policy may be generated to have a low risk of overloading and a high level of available resource utilization.

Previous oversubscription approaches typically have low levels of generalizability across different scenarios in which oversubscription may be performed in a cloud computing environment. For example, in such previous work, the problem of selecting an oversubscription rate in cloud computing has been formulated as a variant of the online bin-packing problem with constraints. Such approaches address a resource allocation policy instead of designing an oversubscription policy. Other prior work focuses on usage migration to mitigate overload situations. However, generalized oversubscription policies, with competing objectives of efficiently utilizing unused capacity while reducing overload risks, have been underexplored.

The optimal oversubscription problem is posed herein as sequential decision-making problem with constraints or resource limits. Predicting future utilization behaviors given historical observations through traditional supervised learning approaches is insufficient, since such approaches are unaware of the interactions between the users and their environments. In approaches such as constrained reinforcement learning that aim to solve a Markov decision process (MDP) with constraints, it is challenging to balance different possibly competing objectives. In general, such approaches are not guaranteed to converge to the optimal solution since the problem does not have a convex solution space. Also, in constrained reinforcement learning, it is difficult to design either the ideal set of constraints or even a reasonable learning environment with correct feedback/reward.

An oversubscription reinforcement learner that addresses the above problems is discussed below. Instead of traditional reinforcement learning (RL) approaches, imitation learning (IL) may be leveraged to solve MDP constraint problems in which an expert's policy fulfills the constraints. In the prototypical imitation learning method (PROTOHAIL) discussed below, a reinforcement learner learns to take actions selected based on a set of learned prototypes. The prototypes are data instances that are representative of equivalence classes of expert trajectories. Facilitated by the interpretability of prototypical IL, human-in-the-loop training is used to guide the model toward a closer fulfillment of the objectives of the oversubscription problem. This human-in-the-loop training approach may allow the oversubscription reinforcement learner to generate appropriate oversubscription rates even when the utilization data used in training is noisy, incomplete, or sparse.

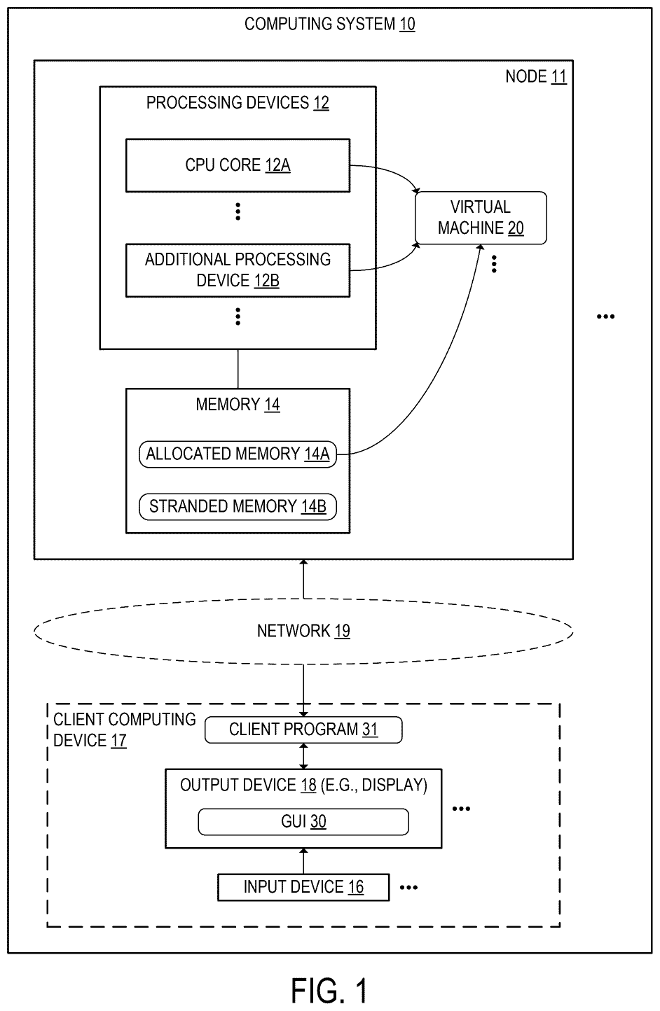

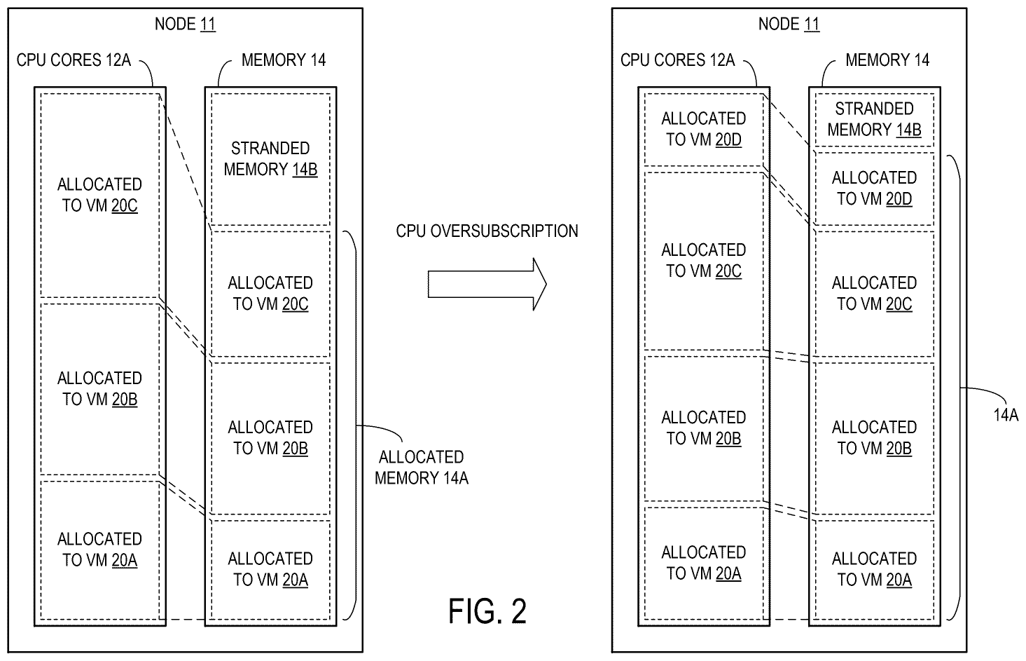

FIGS. 1 and 2 provide context for the problem of setting an oversubscription rate in a cloud computing environment. FIG. 1 schematically depicts a computing system 10 that includes a plurality of nodes 11, according to one example. The nodes 11, as depicted in FIG. 1, are a plurality of networked physical computing devices, which may, for example, be located in a data center. Each of the nodes 11 includes one or more processing devices 12. For example, the one or more processing devices 12 may include one or more central processing unit (CPU) cores 12A. The one or more processing devices 12 may additionally or alternatively include one or more additional processing devices 12B, such as one or more graphics processing units (GPUs), field-programmable gate arrays (FPGAs), specialized hardware accelerators, and/or other types of processing devices 12. Each of the nodes 11 further includes memory 14 that is communicatively coupled to the one or more processing devices 12. The memory 14 may, for example, include one or more volatile memory devices and/or one or more non-volatile memory devices.

The computing system 10 shown in the example of FIG. 1 further includes one or more input devices 16 and one or more output devices 18 communicatively coupled to the plurality of nodes 11. The one or more input devices 16 may, for example, include a keyboard, a mouse, a touchscreen, a microphone, an optical sensor, and/or one or more other types of input devices. The one or more output devices 18 may, for example, include a display, a speaker, a haptic feedback device, and/or one or more other types of output devices. In the example of FIG. 1, the one or more output device 18 include a display. The one or more input devices 16 and the one or more output devices 18 are communicatively coupled with the one or more processing devices 12 such that a graphical user interface (GUI) 30 that allows a user to interact with the one or more processing devices 12 is displayed at the one or more output devices 18 and is configured to receive input via the one or more input devices 16.

In some examples, the one or more input devices 16 and the one or more output devices 18 at which the GUI 30 is displayed are located at a client computing device 17 that is included in the computing system 10 and is coupled to the plurality of nodes 11 over a network 19. A client program 31 executed at the client computing device 17 is configured to transmit input data to, and receive output data from, one or more of the nodes 11. In addition, the client program 31 is configured to receive user inputs and convey outputs to the user via the GUI 30. In other examples, the GUI 30 may be implemented at a node 11 of the plurality of nodes 11 that is locally coupled to the one or more input devices 16 and the one or more output devices 18. The one or more input devices 16 and the one or more output devices 18 may also be located in a plurality of physical computing devices in some examples.

In the example of FIG. 1, a plurality of virtual machines (VMs) 20 are executed at the depicted node 11. Each of the VMs 20 may utilize one or more CPU cores 12A and/or one or more additional processing devices 12B as computing resources. In addition, the VMs 20 each utilize respective portions of allocated memory 14A. Network bandwidth used during communication between a VM 20 and a client computing device 17 over the network 19 may also be a computing resource utilized by the VM 20.

In cloud computing settings, processing device, memory, and network bottlenecks may occur, with processor bottlenecks typically being the most common computing resource bottlenecks. FIG. 1 shows the computing system 10 when a processing device bottleneck occurs at the node 11. The processing bottleneck results in the memory 14 of the node 11 not being fully allocated to the plurality of VMs 20, thereby leaving stranded memory 14B that goes unutilized.

FIG. 2 shows memory underutilization at the node 11 in further detail. In the example of FIG. 2, three VMs 20A, 20B, and 20C are executed at the node 11. The CPU cores 12A of the node 11 are fully allocated to the VMs 20A, 20B, and 20C, whereas a portion of the memory 14 not allocated to the VMs 20A, 20B, and 20C is left as stranded memory 14B. The portion of the physical CPU that is assigned to a VM 20 is known as virtual CPU (vCPU).

FIG. 2 further shows the node 11 when oversubscription has been performed, such that an additional VM 20D is executed at the node 11. Although the vCPU shares nominally allocated to the VMs 20A, 20B, and 20C are the same amounts that would be allocated without oversubscription, the vCPU shares actually used by the VMs 20A, 20B, and 20C are lower than the nominal amounts. Thus, the additional VM 20D is executed on the CPU cores 12A of the node 11 in addition to the VMs 20A, 20B, and 20C. Memory is also allocated to the VM 20D, thereby reducing the amount of stranded memory 14B. Accordingly, FIG. 2 demonstrates an increase in computing resource utilization efficiency achieved using oversubscription.

Oversubscription rates for the nodes 11 may be dynamically adjusted, as discussed in further detail below. For different computing workloads hosted on VMs 20, vCPU usage varies according to different patterns over time. For example, services like email and work-related software demonstrate daily and weekly patterns in regions with similar time zones. Such services typically receive peak traffic during the daytime on weekdays, such that vCPU usage is high during these time periods and low at nighttime and on weekends. On the other hand, services providing social media and video game applications show different vCPU usage patterns in which peak usage occurs during users' spare time. Other non-user-facing services running regularly, like monitoring and maintenance services, sometimes do not show daily or weekly patterns, but instead exhibit patterns caused by underlying configurations set by service teams. The diverse vCPU usage patterns of different services motivate adaptive oversubscription of the vCPUs of VMs used for such services. For example, services may be oversubscribed during periods of predicted low vCPU usage.

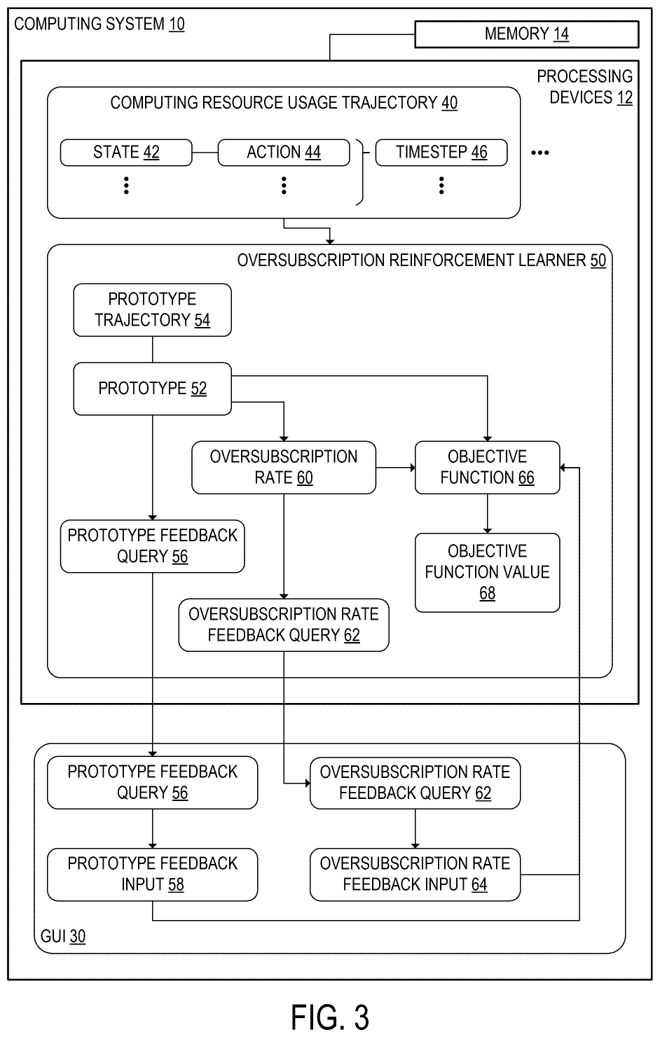

Turning now to FIG. 3, the computing system 10 is shown when an example oversubscription reinforcement learner 50 is trained during a training phase. The oversubscription reinforcement learner 50 is trained to output an oversubscription rate 60. Training the oversubscription reinforcement learner 50 includes, at the one or more processing devices 12, receiving a plurality of computing resource usage trajectories 40. The computing resource usage trajectories 40, as shown in the example of FIG. 3, are sequences of state-action pairs that each include a state 42 and a corresponding action 44. The state-action pairs are associated with respective timesteps 46. The states 42 indicate computing resource usage levels at the timesteps 46, and the actions 44 indicate oversubscription rates 60. A computing resource usage trajectory 40 may be denoted as τ={(s₁, a₁, . . . , s_{T}, a_{T})}, where T is the time horizon, sₜ∈ [symbol] ^{d} is the state at time t, and aₜ∈ [symbol] is the action at time t.

The techniques provided herein to generate the oversubscription rate 60 utilize prototype learning. In prototype learning, a machine learning model compares new inputs to prototypes that act as exemplar cases. A machine learning model trained using prototype learning may exhibit intrinsic interpretability due to the dependence of the model's behavior on a small number of prototypes. Thus, users may interpret the policy learned by the reinforcement learner in terms of the prototypes. In the example of FIG. 3, training the oversubscription reinforcement learner 50 includes, generating, at the oversubscription reinforcement learner 50, a plurality of prototypes 52 that encode respective prototype trajectories 54. The prototypes 52 are generated based at least in part on the plurality of computing resource usage trajectories 40. The one or more processing devices 12 generate the prototypes 52 in the form of vectors pₖ∈ [symbol] ^{m} in the example of FIG. 3. The prototypes pₖ are indexed by k={1,2, . . . , K}; K<<T.

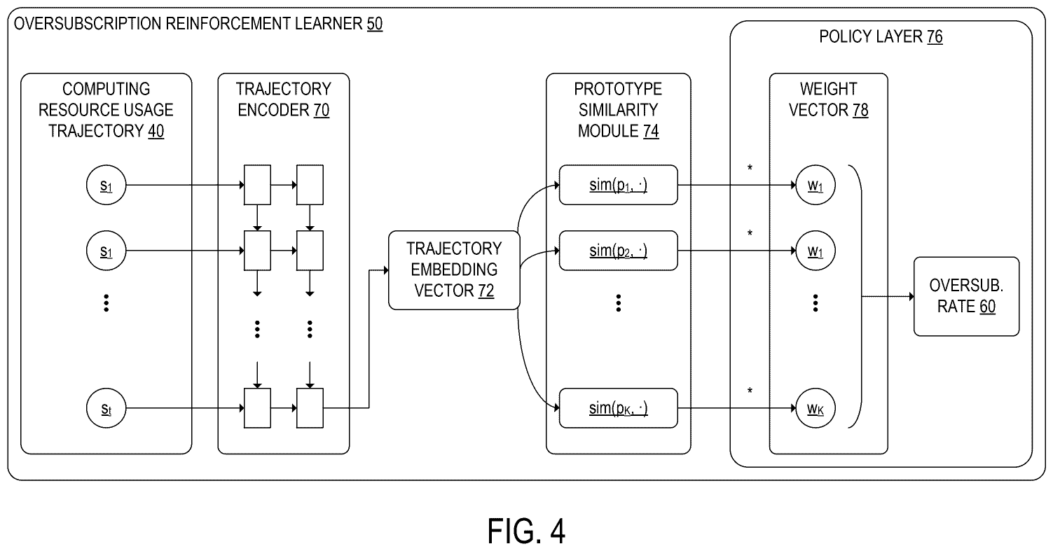

The one or more processing devices 12 are further configured to generate an oversubscription rate 60 based at least in part on the plurality of prototypes 52. FIG. 4 schematically shows the oversubscription reinforcement learner 50 in additional detail when the oversubscription rate 60 is generated, according to one example. In the example of FIG. 4, the oversubscription reinforcement learner 50 includes a trajectory encoder 70 that receives the plurality of computing resource usage trajectories 40. The trajectory encoder 70 may be a transformer encoder, a long short-term memory (LSTM) encoder, or some other type of sequence encoder model. At the trajectory encoder 70, the one or more processing devices 12 generate a plurality of trajectory embedding vectors 72 corresponding to the computing resource usage trajectories 40. The trajectory encoder 70 applies a function f: [symbol] ^{D}→ [symbol] ^{m} to the computing resource usage trajectory τₜ to generate the m-dimensional trajectory embedding vector hₜ=f(τₜ). The trajectory embedding vectors hₜ and the prototype vectors pₖ each have the same length m.

The oversubscription reinforcement learner 50, as shown in FIG. 4, further includes a prototype similarity module 74 that is configured to receive the plurality of trajectory embedding vectors 72. At the prototype similarity module 74, for each trajectory embedding vector hₜ, the one or more processing devices 12 are further configured to compute similarity levels between the trajectory embedding vector hₜ and each of the prototypes pₖ. The similarity metric used at the prototype similarity module 74 may, for example, be the L₂ norm. Alternatively, the prototype similarity module 74 may use some other similarity metric such as the L₁ norm. The vector of similarity values computed at the prototype similarity module 74 may be expressed as P=[sim(f(τₜ), p₁), . . . , sim(f(τₜ), pₖ)].

The oversubscription reinforcement learner 50 further includes a policy layer 76 at which a product of the prototype similarity vector P and a weight vector 78 is computed. The weight vector 78 may be expressed as w=[w₁, . . . , w_{K}]. Thus, the oversubscription rate 60 is computed as a=wP. Thus, a corresponding oversubscription rate 60 is computed at the oversubscription reinforcement learner 50 for each of the computing resource usage trajectories 40.

In the human-in-the-loop (HITL) approach utilized when training the oversubscription reinforcement learner 50, the one or more processing devices 12 generate a prototype feedback query 56 associated with a prototype 52 of the plurality of prototypes 52. The one or more processing devices 12 further output the prototype feedback query 56 to a user interface, which is the GUI 30 in the example of FIG. 3. At the GUI 30, a user may select prototype feedback input 58. The one or more processing devices 12 may accordingly receive the prototype feedback input 58 via the user interface in response to outputting the prototype feedback query 56.

The one or more processing devices 12 further generate an oversubscription rate feedback query 62 that indicates the oversubscription rate 60. The oversubscription rate feedback query 62 is output to the user interface, either along with or separately from the prototype feedback query 56. The user may select an oversubscription rate feedback input 64 at the GUI 30 for transmission to the one or more processing devices 12. Thus, the one or more processing devices 12 may receive the oversubscription rate feedback input 64 via the user interface in response to outputting the oversubscription rate feedback query 62. As discussed in further detail below, the prototype feedback input 58 and the oversubscription rate feedback input 64 may be used as inputs to an objective function 66 when computing an objective function value 68. Thus, the user feedback shapes the oversubscription policy generated at the oversubscription reinforcement learner 50 over the course of training.

The one or more processing devices 12 compute the objective function value 68 based at least in part on the plurality of computing resource usage trajectories 40, the plurality of prototypes 52, the prototype feedback input 58, and the oversubscription rate feedback input 64. The one or more processing devices 12 then train the oversubscription reinforcement learner 50 based at least in part on the objective function value 68. In some examples, the objective function 66 is a loss function for which the one or more processing devices 12 are configured to estimate a minimum value. Alternatively, the objective function 66 may be a reward function for which the one or more processing devices 12 are configured to estimate a maximum value. During training of the oversubscription reinforcement learner 50, the one or more processing devices 12 may modify the weights of the trajectory encoder 70 and the policy layer 76 using a stochastic gradient descent algorithm that receives the objective function value 68 as an input.

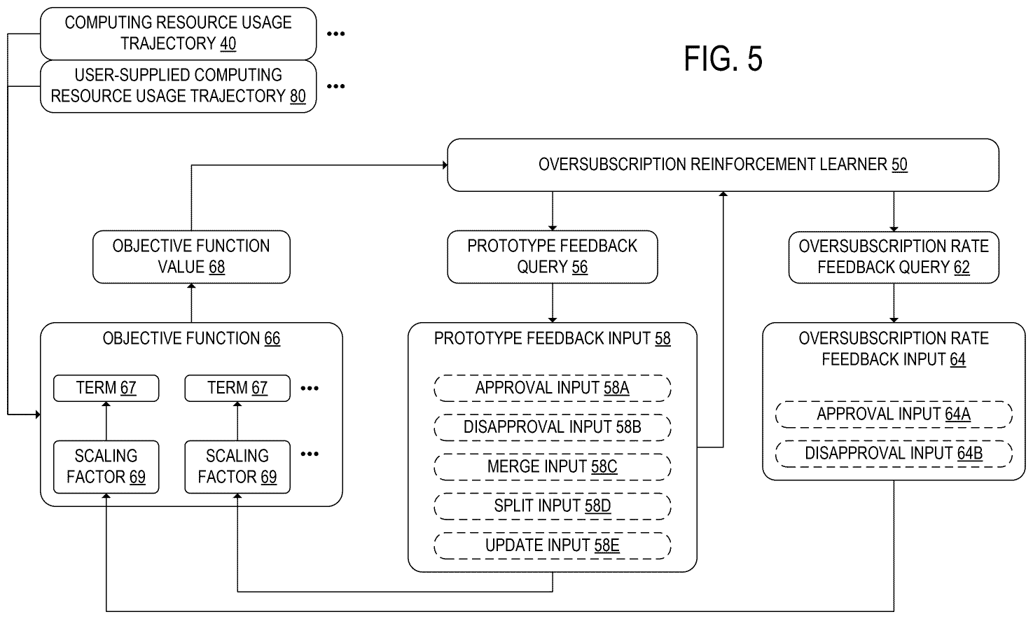

FIG. 5 shows the prototype feedback input 58 in additional detail. As depicted in the example of FIG. 5, the prototype feedback input 58 may be an approval input 58A, a disapproval input 58B, a merge input 58C, a split input 58D, or an update input 58E. Alternatively, the user may provide a null input, thereby skipping the step of providing prototype feedback input 58 for that prototype 52. The prototype feedback input 58 may be used to compute scaling factors 69 applied to terms of the objective function 66, as shown in the example of FIG. 5. For example, as discussed in further detail below, the numbers of approval inputs 58A and disapproval inputs 58B received in prototype feedback inputs 58 may be used to compute the one or more of the scaling factors 69. The oversubscription reinforcement learner 50 may merge two prototypes 52 in response to receiving a merge input 58C and may split a prototype 52 into a plurality of prototypes 52 in response to receiving a split input 58D. The user may also edit one or more parameters of a prototype 52 by providing an update input 58E.

FIG. 5 further shows the oversubscription rate feedback input 64 in additional detail. The oversubscription rate feedback input 64 may be an approval input 64A or a disapproval input 64B. The numbers of approval inputs 64A and disapproval inputs 64B received in oversubscription rate feedback inputs 64 may also be used to compute one or more of the scaling factors 69.

In addition to utilizing the prototypes 52, the oversubscription reinforcement learner 50 of FIG. 3 makes use of imitation learning. However, previous IL methods may be ill-suited to the oversubscription problem in some scenarios. Learning a decision-making policy or a predictive model may be challenging in the presence of (1) systematic noise (sample/feedback sparsity/noise, delayed signals, cognitive bias, sub-optimal trajectories, etc.), (2) non-stationarity, and/or (3) safety concerns in which unsafe exploration has a high cost. Also, in complex decision problems, suitable reward design may be intractable. Thus, entirely data-driven learning may be risky. Even when learning from demonstrations, such as in inverse RL, offline RL, or previous forms of IL, the trajectories may still be noisy, and imperfect human guidance may result in errors. Some related approaches exploit prior knowledge, such as value-based priors or preference-based priors on the decision space, while others include constraints on the imitation objective based on domain knowledge or encode knowledge as reward-shaping functions. In addition, some approaches use statistical models as priors, such as probabilistic model-based imitation learning for handling uncertainty in trajectories. Examples of existing interactive HITL imitation frameworks include Guided Behavior Cloning, DAGGER, and HgDAGGER. However, such HITL imitation frameworks have naïve and inefficient feedback elicitation mechanisms and do not support multi-level feedback.

When training the oversubscription reinforcement learner 50, imitation learning may be performed using expert-supplied data. As shown in the example of FIG. 5, training the oversubscription reinforcement learner 50 further includes receiving one or more user-supplied computing resource usage trajectories 80. The one or more user-supplied computing resource usage trajectories 80 may each include a plurality of user-supplied state-action pairs associated with respective timesteps. In some examples, the one or more user-supplied computing resource usage trajectories 80 may be received via the user interface. The user may, for example, select the one or more user-supplied computing resource usage trajectories 80 from a set of historical computing resource usage trajectory data as examples of frequently occurring patterns in the historical data.

The one or more processing devices 12 further perform imitation learning of the plurality of prototypes 52 based at least in part on the one or more user-supplied computing resource usage trajectories 80. The one or more user-supplied computing resource usage trajectories 80 may be used when computing one or more terms 67 of the objective function 66, as discussed in further detail below.

A formal description of prototypical imitation learning is now provided. Prototypical imitation learning is a type of imitation learning that learns to make a decision by aligning a generated prototype 52 with a reference prototype (a prototypical trajectory) from an expert's policy (in the example of FIG. 5, a user-supplied computing resource usage trajectory 80). Specifically, each prototype 52 may be represented by a prototypical pattern received from the expert. Prototypical imitation learning learns a metric space in which decision-making may be performed by computing the distances to the expert's prototype policies.

Let τ={(s₁, a₁, . . . , s_{T}, a_{T})} be the user-supplied computing resource usage trajectory 80, where T is the time horizon, sₜ∈ [symbol] ^{d} is the state at time t, and aₜ∈ [symbol] is the action at time t. The goal of prototypical imitation learning is to learn representative prototypes pₖ that interpretably represent equivalence classes of patterns in the computing resource usage data. Thus, the prototypes pₖ may be used as decision-making references and in analogical explanations of computing resource usage trends. When a new input state is received, the similarity of that input state is measured relative to each of the representative trajectories of the prototypes pₖ in the learned latent space. Then the prediction of the new action (the oversubscription rate 60 in the example of FIG. 3) may be derived and explained by the closest prototype trajectories.

In the oversubscription problem, the state space is factored with a hybrid feature vector including temporal features. The action/decision space is the space of possible oversubscription rates 60, which is continuous. Thus, the oversubscription problem may be too complex to solve with straightforward behavior cloning. Instead, the trajectories are embedded into a latent space of equivalence classes or prototypes, and approximate symmetries among the trajectory patterns are exploited.

Prototypical imitation learning may be performed in three main phases. The first phase is a prototype discovery phase in which trajectories are classified into K groups. From the trajectory groups, the oversubscription reinforcement learner 50 learns a prototype projection trajectory pₖ, where pₖ is an m-dimensional vector. The second phase is an action policy learning phase at which the action policy is aligned with similar prototypes pₖ at a plurality of states. The third phase is a feedback phase in which the oversubscription reinforcement learner 50 receives feedback from the human in the loop to assess the prototypes pₖ and to obtain feedback on the level of overloading risk incurred by the policy.

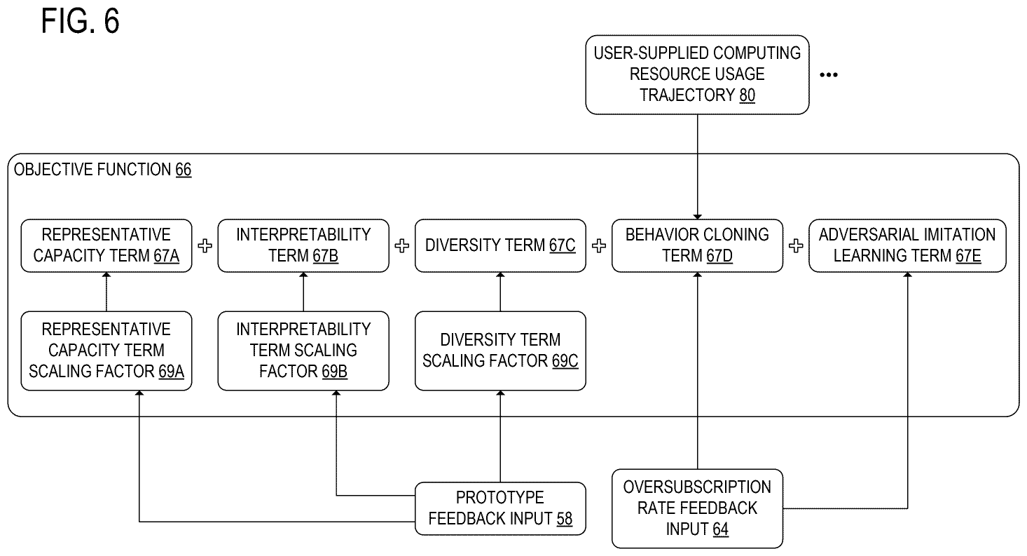

FIG. 6 schematically shows the objective function 66 of the oversubscription reinforcement learner 66 in additional detail, according to one example. The objective function 66 shown in the example of FIG. 6 is a loss function that the oversubscription reinforcement learner 50 is trained to approximately minimize. In the example of FIG. 6, the objective function 66 includes a representative capacity term 67A, an interpretability term 67B, a diversity term 67C, a behavior cloning term 67D, and an adversarial imitation learning term 67E. Prototype discovery may be performed using the representative capacity term 67A and the diversity term 67C, and prototype projection may be performed using the interpretability term 67B. The behavior cloning term 67D and the adversarial imitation learning term 67E may be used to implement imitation learning. The objective function 66 may be a weighted sum of the plurality of terms 67 in which each of the terms has an associated hyperparameter weight.

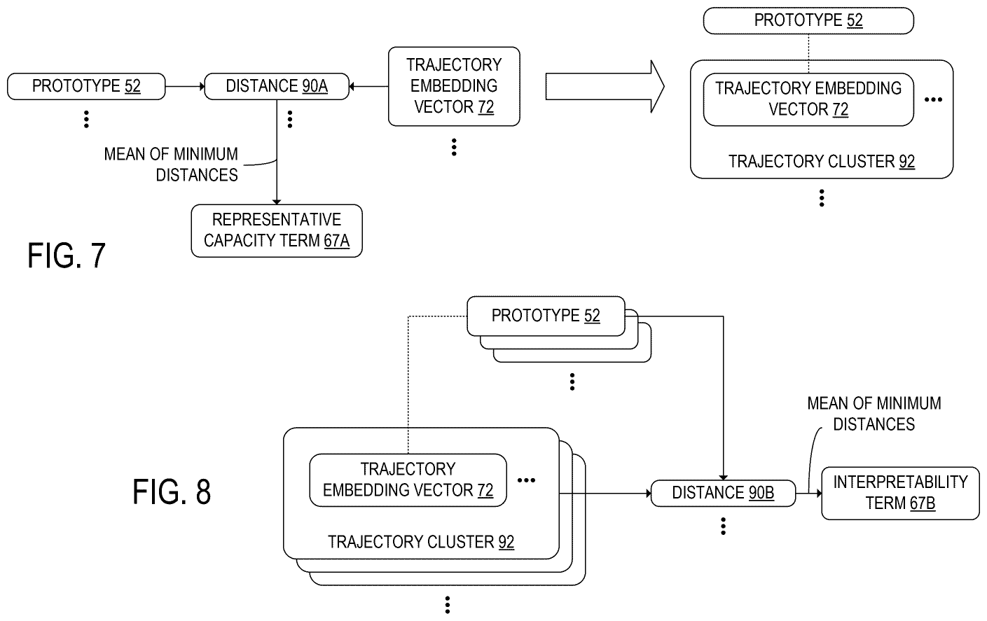

FIGS. 7-10 schematically show the computation of the terms of the objective function 66 in some examples. The representative capacity term 67A may, as shown in the example of FIG. 7, be proportional to a sum of distances 90A between the plurality of prototypes 52 and respective closest trajectory embedding vectors 72 to those prototypes 52. The representative capacity term 67A may be given by the following equation:

$${ℒ}_{rep} = \frac{1}{K} {\sum }_{k = 1}^{K} {min}_{{τ}_{t} ∈ {τ}_{k}} {‖ {p}_{k} - f ( {τ}_{t} ) ‖}_{2}^{2}$$

When the representative capacity term 67A is included in the objective function 66, the trajectory embedding vectors 72 are grouped into K trajectory clusters 92 in the embedding space around respective prototypes 52.

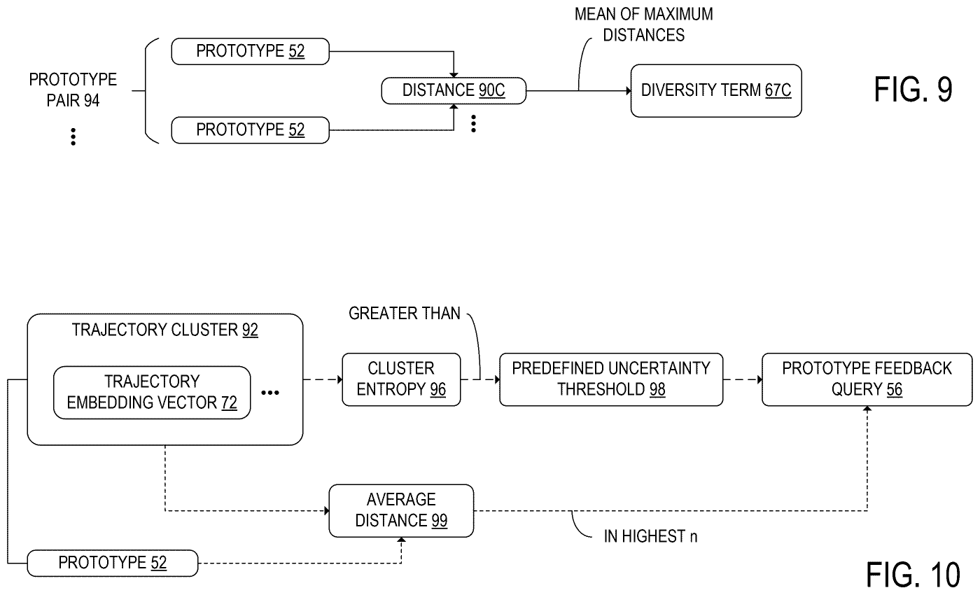

FIG. 8 schematically shows computation of the interpretability term 67B, according to one example. In the example of FIG. 8, the one or more processing devices 12 group the plurality of trajectory embedding vectors 72 into a plurality of trajectory clusters 92 corresponding to the plurality of prototypes 52. The trajectory clusters 92 may be the trajectory clusters induced by the representative capacity term 67A, as shown in the example of FIG. 7. When the oversubscription reinforcement learner 50 is trained using the trajectory clusters 92, the prototypes 52 may be matched to representative members of the trajectory clusters 92. In examples in which the oversubscription reinforcement learner 50 is trained using the representative capacity term 67A and the interpretability term 67B concurrently, as shown in the example of FIG. 6, the one or more processing devices 12 may iteratively adjust the clustering structure of the trajectory embedding vectors 72 that is used to compute the interpretability term 67B.

In the example of FIG. 8, the interpretability term 67B is proportional to a sum of distances 90B between the plurality of prototypes 52 and respective closest trajectory embedding vectors 72 within the corresponding trajectory clusters 92 associated with those prototypes 52. The interpretability term 67B may be given by the following equation:

$${ℒ}_{inf} = \frac{1}{K} {\sum }_{k = 1}^{K} min {‖ {p}_{k} - f ( {τ}^{k} ) ‖}_{2}^{2}$$

In the above equation, τ^{k} is the nearest trajectory to pₖ. The distance 90B is an L₂ norm, and the interpretability term 67B is computed as a mean of the minimum distances. Thus, the interpretability term 67B may allow each prototype 52 to be analogized to the trajectory embedding vector 72 of a real-world computing resource usage trajectory 40.

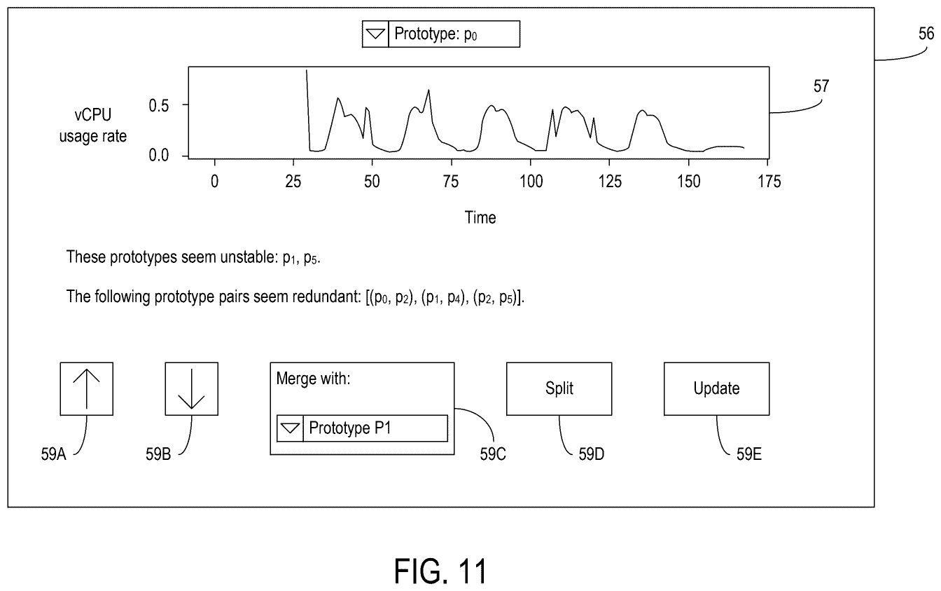

FIG. 9 schematically shows the computation of the diversity term 67C included in the objective function 66. In the example of FIG. 9, the diversity term 67C is proportional to a sum of maximum distances 90C between pairs 94 of the prototypes 52. The diversity term 67C may be given by the following equation:

$${ℒ}_{div} = \frac{1}{K} {\sum }_{i = 1}^{K} {\sum }_{j = i + 1}^{K} max {‖ {p}_{i} - {p}_{j} ‖}_{2}^{2}$$

In the above equation, the distance 90C is an L₂ norm, and the diversity term 67C is computed as the mean of the maximum distances 90C between the prototypes 52 included in the pairs 94. The diversity term 67C penalizes prototypes 52 that are close to each other, thereby allowing the oversubscription reinforcement learner 50 to model a wider range of computing resource usage trajectories 40 using the prototypes 52.

Returning to the example of FIG. 6, imitation learning is implemented at least in part with a behavior cloning term 67D and adversarial imitation learning term 67E included in the objective function 66. In the equations for the behavior cloning term 67D and the adversarial imitation learning term 67E discussed below, π(a|τₜ,P) is a policy layer 76 that learns to take an action aligning with the prototypes 52. The policy layer 76 may be expressed as follows:

$$π ( a \vert {τ}_{t} , P ) = φ ( [ sim ( f ( {τ}_{t} ) , {p}_{1} ) , … , sim ( f ( {τ}_{t} ) , {p}_{K} ) ] )$$

In the above equation, φ is a SoftMax layer, and

$$sim ( f ( {τ}_{t} ) , {p}_{k} ) = - {‖ f ( {τ}_{t} ) - {p}_{k} ‖}_{2}^{2}$$

is the negative Euclidean distance indicating the distance between the trajectory embedding vector 72 and the prototype 52.

The behavior cloning term 67D measures the extent to which the oversubscription rate 60 computed at the oversubscription reinforcement learner 50 mimics the user-supplied oversubscription rate included in the user-supplied computing resource usage trajectory 80 at each timestep. The behavior cloning term 67D may be given by the following equation:

$${ℒ}_{{IM}_{BC}} = {\sum }_{〈 s , {a}^{E} 〉 ∼ {τ}^{E}} [ {π}_{E} ( {a}^{E} \vert {τ}_{t} ) log π ( a \vert {τ}_{t} , P ) ]$$

In the above equation, τ^{E} are the user-supplied computing resource usage trajectories 80 and π_{E} is the policy of a user-supplied computing resource usage trajectory 80. Thus, the oversubscription reinforcement learner 50 may learn to imitate user-supplied computing resource usage trajectories 80.

When adversarial imitation learning is performed, the oversubscription reinforcement learner 50 may learn to decrease the Jensen-Shannon (JS) divergence between the distribution of computing resource usage trajectories generated by the oversubscription reinforcement learner 50 and the distribution of user-supplied computing resource usage trajectories 80. The adversarial imitation learning term 67E may be given by the following equation:

$${ℒ}_{{IM}_{AIL}} = {\sum }_{〈 s , {a}^{E} 〉 ∼ τ} [ {D}_{KL} ( {ρ}_{π ( a \vert {τ}_{t} , P )} ‖ \frac{{ρ}_{π ( a \vert {τ}_{t} , P )} + {ρ}_{{π}_{E}}}{2} ) + {D}_{KL} ( {ρ}_{{π}_{E}} ‖ \frac{{ρ}_{{π}_{o} ( a \vert s , {e}_{o} )} + {ρ}_{{π}_{E}}}{2} ) ]$$

where D_{KL} is the Kullback-Leibler divergence,

$${ρ}_{π} ( {τ}_{t} , a ) = π ( a \vert {τ}_{t} , P ) {\sum }_{t = 1}^{T} γ P ( {s}_{t} \vert π )$$

is the distribution of state-action pairs with policy π, and γ is a discounting factor. Accordingly, including the adversarial imitation learning term 67E in the objective function may result in the oversubscription reinforcement learner 50 generating oversubscription rates 60 that have a similar distribution to the distribution of oversubscription rates included in the user-supplied computing resource usage trajectories 80.

By combining the terms 67 discussed above, the full objective function 66 shown in FIG. 6 may be given by:

$${ℒ}_{Full} = {w}_{1} \cdot {ℒ}_{rep} + {w}_{2} \cdot {ℒ}_{int} + {w}_{3} \cdot {ℒ}_{div} + {w}_{4} \cdot {ℒ}_{{IM}_{loss}}$$

In the above equation, w₁, w₂, w₃, w₄∈[0,1] are hyperparameters that are used to balance the weights of the loss terms. [symbol] _{1M}_{ₗₒₛₛ} may be equal to [symbol] _{1M}_{_{BC}}, [symbol] _{1M}_{_{AIL}}, or a linear combination thereof.

The policy π may be reinterpreted as a quadratic model. P represents the similarity vector [sim(f(τₜ),p₁), . . . , sim(f(τₜ),pₖ)] in the equation for It discussed above. The policy π may be rewritten in quadratic form as follows:

$$π = φ ( - {‖ f ( {τ}_{t} ) - {p}_{1} ‖}_{2}^{2} , … , - {‖ f ( {τ}_{t} ) - {P}_{K} ‖}_{2}^{2} )$$

where φ is a fully connected layer with only linear operators. π may then be further rewritten as:

$$π = - {b}_{1} {‖ f ( {τ}_{t} ) - {p}_{1} ‖}_{2}^{2} - {b}_{2} {‖ f ( {τ}_{t} ) - {p}_{2} ‖}_{2}^{2} - , … , - {b}_{K} {‖ f ( {τ}_{t} ) - {p}_{K} ‖}_{2}^{2}$$

where bᵢ, i=1, . . . , K are the values of the linear neurons in the fully connected layer. The terms of π may be converted into linear form as follows:

$$- {b}_{k} {‖ f ( {τ}_{t} ) - {p}_{k} ‖}_{2}^{2} = - {b}_{k} {f ( {τ}_{t} )}^{T} f ( {τ}_{t} ) + 2 {b}_{k} {p}_{k}^{T} f ( {τ}_{t} ) - {b}_{k} {p}_{k}^{T} {p}_{k}$$

On the righthand side of the above equation, the first term is a quadratic term in f(τₜ), the second term may be treated

$${w}_{k}^{T} f ( {τ}_{t} ) ,$$

where wₖ=2bₖpₖ, and the third term may be treated as a constant term in f(τₜ).

Starting from the quadratic rewrite of the policy π, the action may be interpreted as a summation of K quadratic functions with the same sign in quadratic coefficients with regard to f(τₜ). Thus, the relationship between the action and f(τₜ) may be decomposed to at most two pieces, and within each piece the relationship between the action and f(τₜ) is monotonic. Using the above observation, the policy π may be interpreted more easily.

Returning to the example of FIG. 5, the incorporation of user feedback into the objective function 66 is discussed in further detail. In the domain of VM oversubscription, systematic noise is prevalent in the computing resource usage trajectories 40. This systematic noise may lead to sub-optimal prototype embeddings, prototype selection, and final policies. In order to address systematic noise, the oversubscription reinforcement learner 50 exploits active feedback to refine the learned policy over the prototypes 52. Human feedback is received in the contexts of: (1) feedback over prototypes, including quality of prototype embeddings and prototype alignment and diversity, and (2) feedback on the risk levels of proposed oversubscription rates 60.

To elicit relevant knowledge from human feedback, it is sometimes insufficient to naively query for human feedback at fixed or random intervals, which may actually be counterproductive in some scenarios. Producing informed queries at relevant points may instead allow useful knowledge to be obtained. Relevant prototypes 52 and predicted oversubscription rates 60 are identified when determining points at which a human in the loop is prompted for feedback.

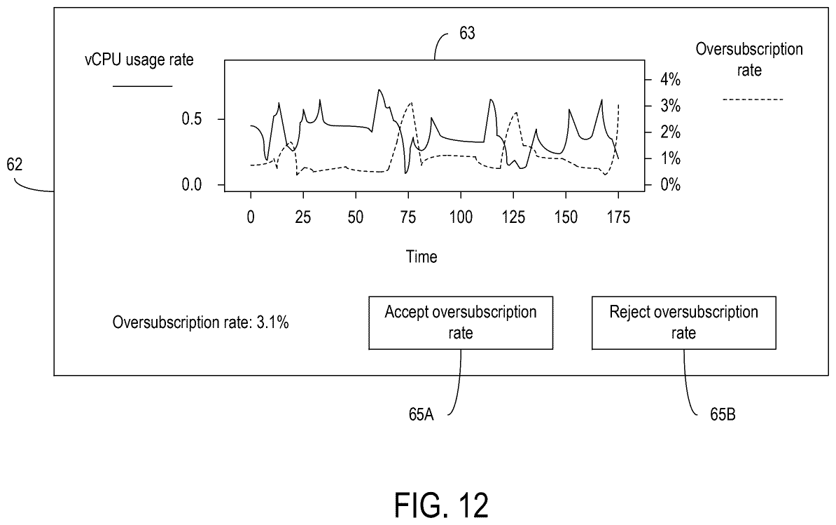

FIG. 10 schematically shows the selection of a prototype 52 for prototype feedback query generation. The prototype 52 in the example of FIG. 10 is associated with a trajectory cluster 92 including a plurality of trajectory embedding vectors 72. The one or more processing devices 12 may compute a cluster entropy 96 of the trajectory cluster 92 associated with the prototype 52. The one or more processing devices 12 may further output the prototype feedback query 56 associated with the prototype 52 in response to determining that the cluster entropy 96 is greater than a predefined uncertainty threshold 98.

Alternatively, the one or more processing devices 12 may select the prototype 52 as a subject of a prototype feedback query 56 based at least in part on an average distance 99 between the prototype 52 and the trajectory embedding vectors 72 included in the trajectory cluster 92 associated with the prototype 52. The one or more processing devices 12 may determine that the average distance 99 is included in a predetermined number of highest average distances among the plurality of prototypes 52. The one or more processing devices 12 may further output the prototype feedback query 56 associated with the prototype 52 in response to this determination. Thus, the prototypes 52 with the highest n average distances may be selected for prototype feedback queries, where n is the predetermined number.

Further detail regarding the generation of the prototype feedback query 56 is provided below. A query q= [symbol] p_{q}, (τ_{q}, â) [symbol] may include a set of prototypes p_{q}⊆ [symbol] and a set of trajectories plus predictions [symbol] τ_{q}, â [symbol] for which feedback is solicited. The action â in the set [symbol] τ_{q}, â [symbol] is the oversubscription rate 60 at a subsequent timestep. In the example of FIG. 5, a prototype feedback query 56 pertaining to one or more prototypes p_{q} and an oversubscription rate feedback query 62 pertaining to one or more sets of trajectories plus predictions [symbol] τ_{q}, â [symbol] are output to the GUI 30 separately. In other examples, the prototype feedback query 56 and the oversubscription rate feedback query 62 may be presented to the user in a combined output to the GUI 30.

In the above expression for the query q, the set of prototypes p_{q} may be given by p_{q}=p_{μ}∩p_{D}, where p_{μ} is defined as:

$${p}_{μ} = \{ {p}^{′} ⊂ 𝒫 , p ∈ {p}^{′} \vert uncertainty μ ( p ) \geq Tr \}$$

$$μ ( p ) = entropy ( P ( {‖ {h}_{j} , p ‖}_{2}^{2} ) ) ; {h}_{j} ∈ p$$

In the above equations, Tr is an uncertainty threshold. The uncertainty is the cluster entropy μ of the prototype p. p_{D} includes prototypes with top-n high average distance from the trajectory embedding vectors h, and is given as follows:

$${p}_{D} = arg {max}_{{p}^{′} ⊂ 𝒫} ( \frac{1}{m} {\sum }_{{h}_{j}} \overline{{‖ h , p ‖}_{2}^{2}} ) , {h}_{j} ∈ ρ , {p}^{′} ⊨ p$$

In the above equation, [symbol] denotes “models.”

The set [symbol] τ_{q}, â [symbol] is determined using both the prediction uncertainty, computed via differential entropy (continuous valued), and the overloading risk. If predicted oversubscription is less than the expected true usage ŷᵢ<yᵢ, the predicted oversubscription is an overloading risk.

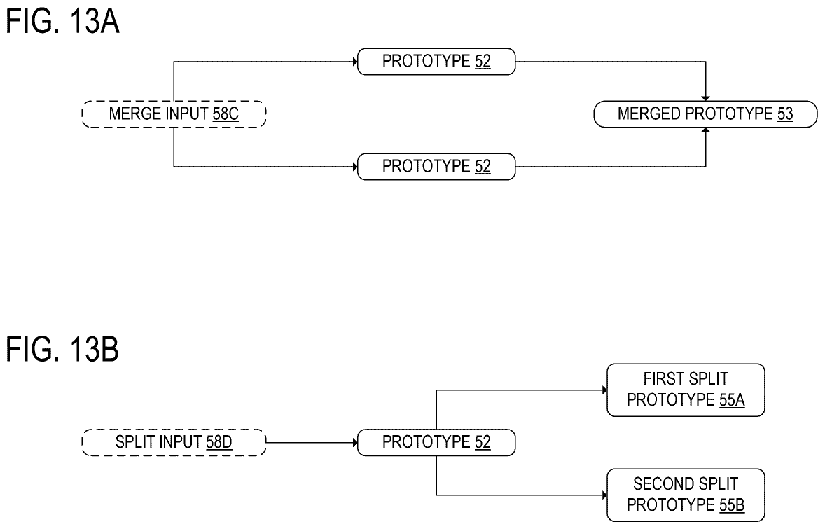

FIG. 11 shows an example prototype feedback query 56 that may be presented to the user at the GUI 30. In the example of FIG. 11, the prototype feedback query 56 includes a prototype visualization 57 of a prototype p₀. The example prototype feedback query 56 further includes indicators that prototypes p₀ and pₛ appear unstable, indicating that these prototypes are included in the high-uncertainty prototype set p_{μ}. In addition, the prototype feedback query 56 includes indicators that the prototype pairs (p₀,p₂), (p₁,p₄), and (p₂,p₅) are redundant. The redundant prototype pairs may, for example, be identified by computing distances 90C in embedding space between pairs 94 of the prototypes 52. In such examples, the pairs 94 with the bottom n distances 90C, for some predetermined number of pairs n, may be indicated in the prototype feedback query 56 as potentially redundant.

The example prototype feedback query 56 of FIG. 11 further includes an approval feedback interface element 59A, a disapproval feedback interface element 59B, a merge feedback interface element 59C, a split feedback interface element 59D, and an update feedback interface element 59E. By selecting the approval feedback interface element 59A, the disapproval feedback interface element 59B, the merge feedback interface element 59C, the split feedback interface element 59D, or the update feedback interface element 59E, the user may respectively enter an approval input 58A, a disapproval input 58B, a merge input 58C, a split input 58D, or an update input 58E as the prototype feedback input 58.

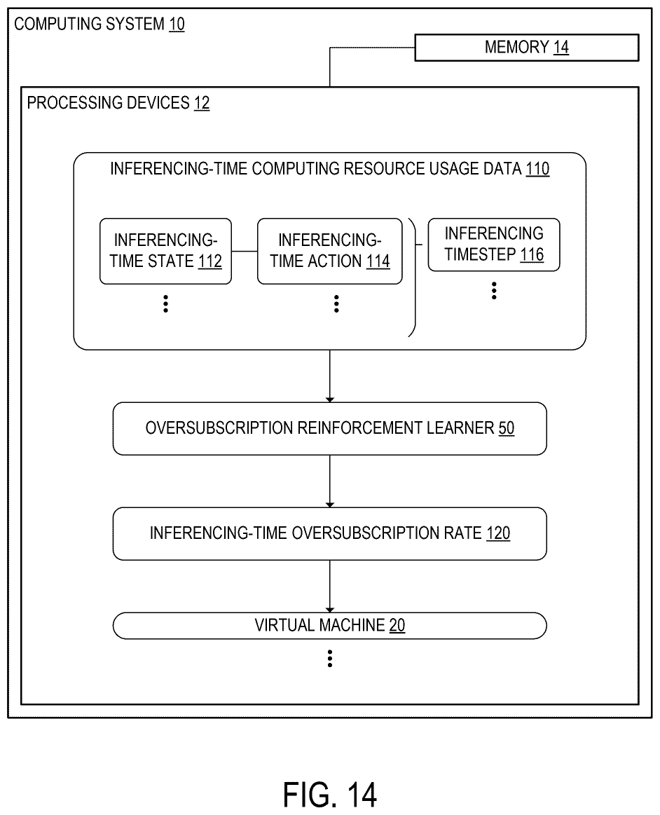

FIG. 12 shows an example oversubscription rate feedback query 62 that may be displayed at the GUI 30. The example oversubscription rate feedback query 62 of FIG. 12 shows a trajectory-prediction visualization 63 of the computing resource usage trajectory 40 and the oversubscription rate 60 for that computing resource usage trajectory 40 as a function of time. The oversubscription rate feedback query 62 further includes an approval feedback interface element 65A and a disapproval feedback interface element 65B via which the user may respectively enter an approval input 64A or a disapproval input 64B as the oversubscription rate feedback input 64.

Returning to the example of FIG. 6, the computation of the representative capacity term scaling factor 69A, the interpretability term scaling factor 69B, and the diversity term scaling factor 69C is now discussed in additional detail. Approval inputs 58A and disapproval inputs 58B may be respectively indicated as (□/↓=+1/−1). For a given prototype pⱼ∈p_{q}, current cumulative feedback [symbol] (pⱼ)=Σ[+1/−1/0]. Similarly, for a trajectory-action pair indicated in an oversubscription rate feedback query 62, [symbol] (τᵢ, âᵢ)=Σ[+1/−1/0] for τᵢ, âᵢ∈ [symbol] τ_{q}, â [symbol] .

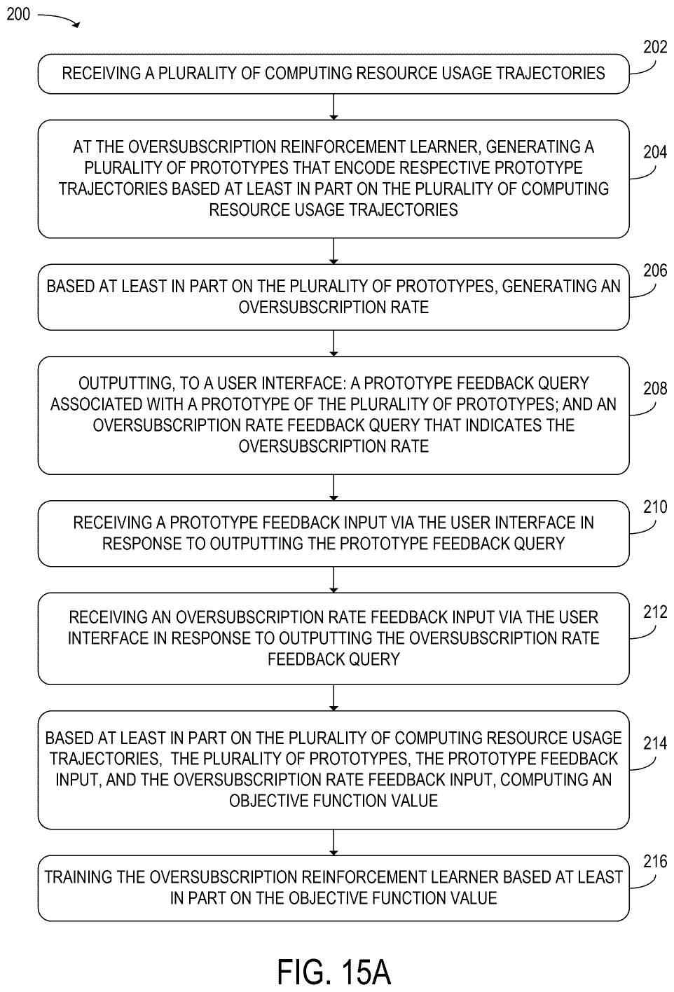

FIG. 13A schematically shows the processing of a merge input 58C received as the prototype feedback input 58. In response to receiving the merge input 58C as the prototype feedback input 58, the one or more processing devices 12 generate a merged prototype 53 based at least in part on the prototype 52 indicated in the prototype feedback query 56, as well as an additional prototype 52. When a pair of prototypes pⱼ and pₖ are merged, the embeddings of the merged prototype 53 may be computed as the mean of the embeddings of pⱼ and pₖ.

FIG. 13B schematically shows the processing of a split input 58D received as the prototype feedback input 58. In response to receiving the split input 58D as the prototype feedback input 58, the one or more processing devices 12 generate a first split prototype 55A and a second split prototype 55B based at least in part on the prototype 52. When a prototype pₖ is split, first split prototype 55A and the second split prototype 55B may each have trajectories given by:

$$f ( {τ}^{′} ) = arg {max}_{{τ}^{′} ⊂ {τ}_{k} \vert {τ}^{′} ⊨ τ} {‖ {p}_{k} - f ( τ ) ‖}_{2}^{2} ; {τ}_{k} ∈ {p}_{k}$$

In the above equation, τₖ are the trajectories that belong to the cluster associated with pₖ. τ′ in the above equation models, and may be selected by re-clustering, the trajectories τ. For example, performing the re-clustering may include evaluating an argTop-n function over the values of the distance measure in the above equation to thereby select the trajectories τ for which the corresponding trajectory embedding vectors f(τ) have the top n distances from their respective prototypes 52. The one or more processing devices 12 may then re-cluster the trajectories τ by defining a new cluster including the outputs of the argTop-n function.

The HITL feedback included in the prototype feedback input 58 and the oversubscription rate feedback input 64 is incorporated into the objective function 66 using exponential advice gates via which the terms 67 of the objective function 66 are controlled and scaled. Advice potentials selectively alter the objective function value 68 according to context and user feedback. Thus, the advice potentials may drive the training toward model parameters that more closely align with the user's goals. An advice potential gate is a product term with an exponential form Φ= [symbol] , where −∞≤ [symbol] ≤∞ is the current cumulative feedback and 0 is the neutral feedback. Since Φ is exponential, [symbol] is a function that scales [symbol] to [−1, +1]. Thus, unbounded values of Φ are avoided.

With the available feedback over prototypes [symbol] (pⱼ) and feedback over actions [symbol] ( [symbol] τᵢ, âᵢ [symbol] ), and feedback between prototypes [symbol] (pⱼ,pₖ), the objective function 66 of the oversubscription reinforcement learner 50 may be modified as follows:

$${ℒ}_{Full}^{′} = {w}_{1} \cdot {ℒ}_{rep} \times Φ ( {τ}_{i} , {\hat{a}}_{i} ) + {w}_{2} \cdot {ℒ}_{int} \times Φ ( {τ}_{i} , {\hat{a}}_{i} ) \cdot Φ ( {p}_{j} ) + {w}_{3} \cdot {ℒ}_{div} \times Φ ( {p}_{j} , {p}_{k} ) + {w}_{4} \cdot {ℒ}_{{IM}_{loss}}$$

The advice potentials upscale or downscale the relevant terms 67 based on the obtained feedback. In the above equation, the dependences on τᵢ, âᵢ, pⱼ, and pₖ are incorporated into the computation of the total values of [symbol] as discussed above. While the hyperparameters w₁, w₂, w₃, w₄ are static hyperparameters and control the relative contributions of the terms 67, the advice potentials dynamically control the contributions to the objective function value 68 for a given prototype and prediction context. Thus, the advice potentials may allow the oversubscription reinforcement learner 50 to dynamically navigate the objective function landscape toward parameter values that more accurately fulfill the user's goals.

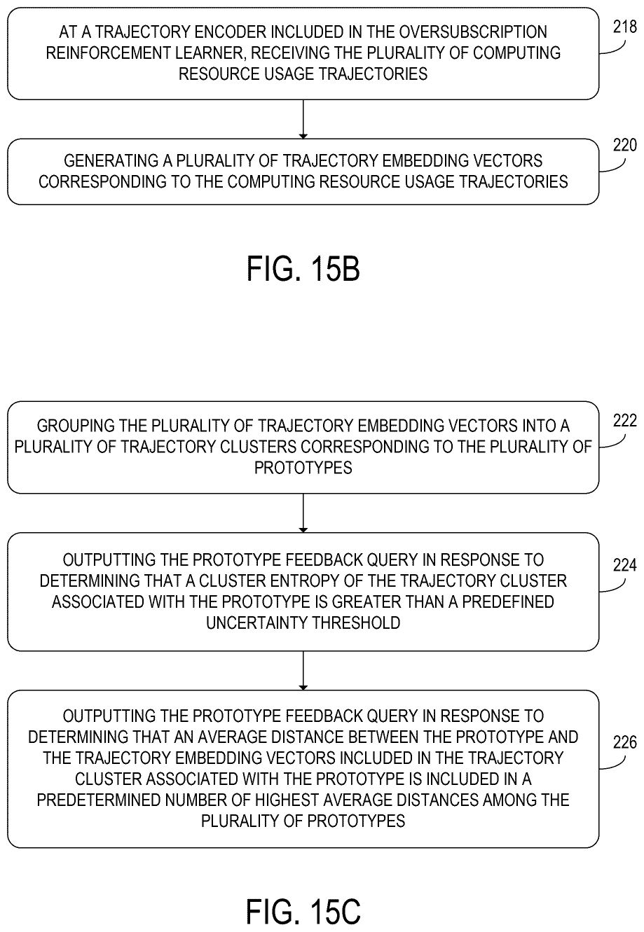

FIG. 14 shows the computing system 10 during an inferencing phase performed subsequently to the training phase. In the inferencing phase, the oversubscription reinforcement learner 50 is used to dynamically set an inferencing-time oversubscription rate 120 in real time. As shown in the example of FIG. 14, the one or more processing devices 12 receive inferencing-time computing resource usage data 110. The inferencing-time-computing resource usage data 110 may include a plurality of inferencing-time states 112 that are paired with respective inferencing-time actions 114 and occurred at respective inferencing timesteps 116. The inferencing-time states 112 may be prior inferencing-time computing resource usage levels and the inferencing-time actions 114 may be prior inferencing-time oversubscription rates.

The one or more processing devices 12 set the inferencing-time oversubscription rate 120 at the oversubscription reinforcement learner 50 based at least in part on the inferencing-time computing resource usage data 110. The one or more processing devices 12 may set the inferencing-time oversubscription rate 120 during the inferencing phase without receiving further feedback from the user. Alternatively, in some examples, one or more phases of additional training utilizing feedback queries and inputs may be performed subsequently to deployment in order to correct for distributional shift.

The one or more processing devices 12 further allocate computing resources to a plurality of virtual machines 20 as specified by the inferencing-time oversubscription rate 120. Thus, the one or more processing devices 12 may allocate vCPU, memory, network bandwidth, or some other computing resource such that the total amount of that computing resource allocated to the plurality of VMs 20 has the specified inferencing-time oversubscription rate 120.

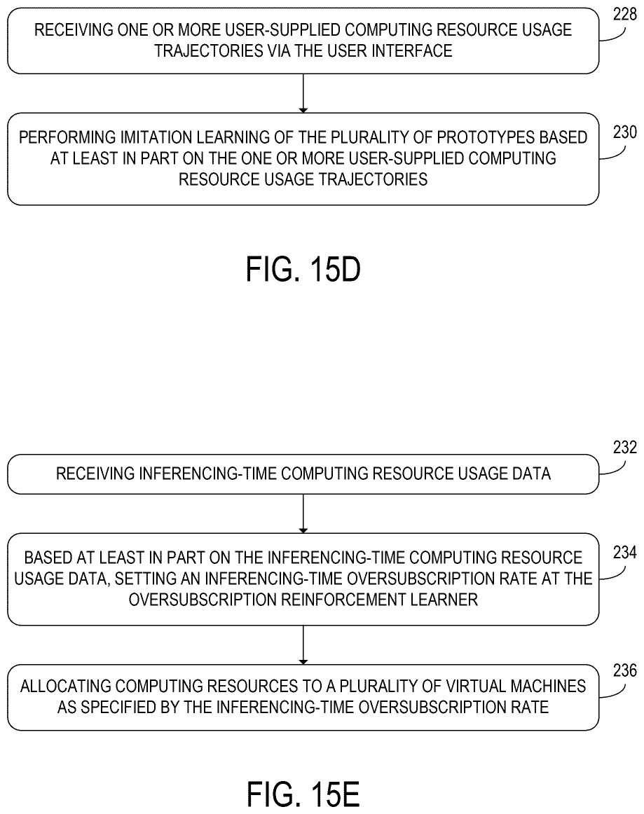

FIG. 15A shows a flowchart of an example method 200 for use with an oversubscription reinforcement learner executed at a computing system. FIG. 15A shows steps that are performed during a training phase in which the oversubscription reinforcement learner is trained. At step 202, the method 200 includes receiving a plurality of computing resource usage trajectories. The computing resource usage trajectories may each include a plurality of state-action pairs associated with respective timesteps. Each state in a state-action pair may be a computing resource usage level and each action may be an oversubscription rate.

At step 204, the method 200 further includes, at the oversubscription reinforcement learner, generating a plurality of prototypes. The plurality of prototypes encode respective prototype trajectories and are generated based at least in part on the plurality of computing resource usage trajectories. Each of the prototypes may be representative of a respective cluster of the computing resource usage trajectories and may be expressed as a vector in an embedding space.

At step 206, the method 200 further includes generating an oversubscription rate based at least in part on the plurality of prototypes. The oversubscription rate may be associated with a computing resource such as vCPU, memory utilization, or network bandwidth. In some examples, the oversubscription rate is specific to a node included among a plurality of nodes in the computing system.

At step 208, the method 200 further includes outputting a prototype feedback query and an oversubscription rate feedback query to a user interface. The prototype feedback query and the oversubscription rate feedback query are prompts for feedback from a human in the loop. The prototype feedback query is associated with a prototype of the plurality of prototypes, and the oversubscription rate feedback query indicates the oversubscription rate.

At step 210, the method 200 further includes receiving a prototype feedback input via the user interface in response to outputting the prototype feedback query. The prototype feedback input may be an approval input, a disapproval input, a merge input, a split input, or an update input. In addition, at step 212, the method 200 further includes receiving an oversubscription rate feedback input via the user interface in response to outputting the oversubscription rate feedback query. The oversubscription rate feedback input may be an approval input or a disapproval input.

At step 214, the method 200 further includes computing an objective function value based at least in part on the plurality of computing resource usage trajectories, the plurality of prototypes, the prototype feedback input, and the oversubscription rate feedback input. The objective function value may be the value of a loss function that the oversubscription reinforcement learner is trained to approximately minimize or a reward function that the oversubscription reinforcement learner is trained to approximately maximize. In some examples, the objective function may include a representative capacity term and an interpretability term, as discussed below. The objective function may additionally or alternatively include a diversity term, which may be proportional to a sum of maximum distances between pairs of the prototypes. One or more imitation learning terms may also be included in the objective function in some examples.

At step 216, the method 200 further includes training the oversubscription reinforcement learner based at least in part on the objective function value. For example, the oversubscription reinforcement learner may be trained via stochastic gradient descent.

FIG. 15B shows additional steps of the method 200 that may be performed in some examples during the training phase. At step 218, the method 200 may further include receiving the plurality of computing resource usage trajectories at a trajectory encoder included in the oversubscription reinforcement learner. The trajectory encoder may, for example, be a transformer encoder or an LSTM encoder. The method 200 may further include, at step 220, generating a plurality of trajectory embedding vectors corresponding to the computing resource usage trajectories. The trajectory embedding vectors may each have the same number of elements as each of the prototypes.

In examples in which the steps of FIG. 15B are performed, the plurality of trajectory embedding vectors may be utilized when computing the value of the objective function. For example, the objective function may include a representative capacity term proportional to a sum of distances between the plurality of prototypes and respective closest trajectory embedding vectors to those prototypes.

FIG. 15C shows additional steps of the method 200 that may be performed in examples in which a plurality of trajectory embedding vectors are generated as shown in FIG. 15B. In such examples, computing the value of the objective function may further include, at step 222, grouping the plurality of trajectory embedding vectors into a plurality of trajectory clusters corresponding to the plurality of prototypes. In such examples, the objective function may include an interpretability term proportional to a sum of distances between the plurality of prototypes and respective closest trajectory embedding vectors within the corresponding trajectory clusters associated with those prototypes.

The clusters of trajectory embedding vectors may be further utilized to determine when the prototype feedback query is output to the user. In such examples, at step 224, the method 200 may further include outputting the prototype feedback query in response to determining that a cluster entropy of the trajectory cluster associated with the prototype is greater than a predefined uncertainty threshold. Additionally or alternatively, at step 226, the method 200 may further include outputting the prototype feedback query in response to determining that an average distance between the prototype and the trajectory embedding vectors included in the trajectory cluster associated with the prototype is included in a predetermined number of highest average distances among the plurality of prototypes. Thus, respective prototype feedback queries may be selectively output for a subset of the prototypes rather than soliciting user feedback for each prototype.

FIG. 15D shows additional steps of the method 200 that may be performed to use imitation learning during training of the oversubscription reinforcement learner. At step 228, the method 200 may further include receiving one or more user-supplied computing resource usage trajectories via the user interface. At step 230, the method 200 may further include performing imitation learning of the plurality of prototypes based at least in part on the one or more user-supplied computing resource usage trajectories. For example, the imitation learning may be implemented at least in part with a behavior cloning term included in the objective function. Additionally or alternatively, the imitation learning may be implemented at least in part with an adversarial imitation learning term included in the objective function. Thus, the oversubscription reinforcement learner may learn to imitate expert-specified oversubscription rates selected for corresponding trajectories.

FIG. 15E shows additional steps of the method 200 that may be performed during an inferencing phase, subsequently to training the oversubscription reinforcement learner. At step 232, the method 200 may further include receiving inferencing-time computing resource usage data. At step 234, the method 200 may further include setting an inferencing-time oversubscription rate at the oversubscription reinforcement learner based at least in part on the inferencing-time computing resource usage data. At step 236, the method 200 may further include allocating computing resources to a plurality of virtual machines as specified by the inferencing-time oversubscription rate. The oversubscription reinforcement learner may accordingly control the oversubscription rate dynamically during real-time operation of the VMs.

Experimental results comparing the oversubscription reinforcement learner 50 (PROTOHAIL) to previous oversubscription rate setting approaches are now discussed. The oversubscription reinforcement learner was trained using historical vCPU utilization data and historical oversubscription rate data collected in a cloud computing environment. The two metrics of oversubscription policy performance used in the experiment were hot node percentage (the percentage of nodes with CPU utilization of 85% or higher) and remaining core number (the number of additional CPU cores that would be made available by oversubscription if the policy were implemented).

PROTOHAIL was compared to other oversubscription approaches including grid search, moving average, deep deterministic policy gradient (DDPG) reinforcement learning, behavior cloning, generative adversarial imitation learning (GAIL), and dataset aggregation (Dagger) imitation learning (with 20 timesteps of human guidance). In addition, the PROTOHAIL was tested without HITL feedback. The oversubscription approaches were tested on a test set of the historical vCPU utilization data and historical oversubscription rate data.

The following table summarizes the experimental results:

| Approach | Hot Node | Remaining Cores |
|---|---|---|
| Grid Search | 0% | 7450 |
| Moving Average | 1.39% | 7628 |
| DDPG | 1.47% | 5030 |
| Behavior Cloning | 1.19% | 7870 |
| GAIL | 1.2% | 6980 |
| Dagger (20 timesteps) | 0.96% | 7938 |
| PROTOHAIL (without | 0% | 8153 |
| HITL) | | |
| PROTOHAIL | 0% | 8161 |

As shown in the above table, PROTOHAIL and PROTOHAIL without human feedback both achieved 0% hot nodes. PROTOHAIL achieved the highest number of remaining cores among the approaches tested, and PROTOHAIL without human feedback achieved the second-highest number of remaining cores. Notably, the PROTOHAIL results were achieved using a machine learning architecture that was developed to be human-interpretable. PROTOHAIL therefore does not exhibit a tradeoff between interpretability and performance, as occurs in many machine learning systems, but instead shows increases in both interpretability and performance relative to previous machine learning approaches such as DDPG, behavior cloning, GAIL, and Dagger.

In some embodiments, the methods and processes described herein may be tied to a computing system of one or more computing devices. In particular, such methods and processes may be implemented as a computer-application program or service, an application-programming interface (API), a library, and/or other computer-program product.

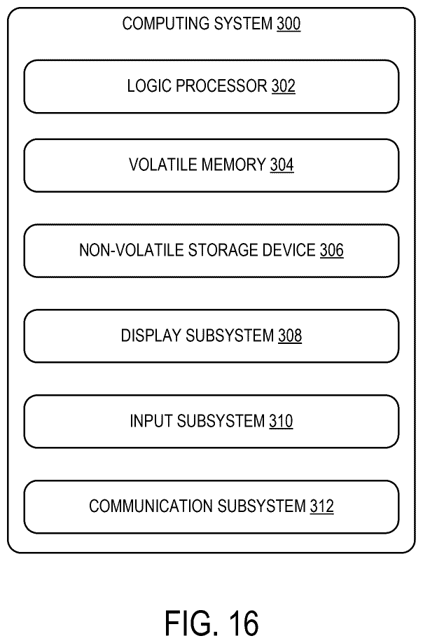

FIG. 16 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Computing system 300 may take the form of one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 16.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local-or wide-area network. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices that, during a training phase, train an oversubscription reinforcement learner at least in part by receiving a plurality of computing resource usage trajectories. Training the oversubscription reinforcement learner further includes, at the oversubscription reinforcement learner, generating a plurality of prototypes that encode respective prototype trajectories based at least in part on the plurality of computing resource usage trajectories. Based at least in part on the plurality of prototypes, training the oversubscription reinforcement learner further includes generating an oversubscription rate. Training the oversubscription reinforcement learner further includes outputting, to a user interface, a prototype feedback query associated with a prototype of the plurality of prototypes and/or an oversubscription rate feedback query that indicates the oversubscription rate. Training the oversubscription reinforcement learner further includes receiving a prototype feedback input via the user interface in response to outputting the prototype feedback query, and/or receiving an oversubscription rate feedback input via the user interface in response to outputting the oversubscription rate feedback query. Based at least in part on the plurality of computing resource usage trajectories, the plurality of prototypes, and the prototype feedback input and/or the oversubscription rate feedback input, training the oversubscription reinforcement learner further includes computing an objective function value. The oversubscription reinforcement learner is trained based at least in part on the objective function value. The above features may have the technical effect of allocating computing resources efficiently via oversubscription while avoiding overloading. In addition, the oversubscription reinforcement learner may generate the oversubscription rate in a human-interpretable manner.

According to this aspect, during an inferencing phase, the one or more processing devices may further receive inferencing-time computing resource usage data. Based at least in part on the inferencing-time computing resource usage data, the one or more processing device may further set an inferencing-time oversubscription rate at the oversubscription reinforcement learner. The one or more processing devices may further allocate computing resources to a plurality of virtual machines as specified by the inferencing-time oversubscription rate. The above features may have the technical effect of allocating computing resources efficiently via oversubscription while avoiding overloading.

According to this aspect, training the oversubscription reinforcement learner may further include receiving one or more user-supplied computing resource usage trajectories via the user interface and performing imitation learning of the plurality of prototypes based at least in part on the one or more user-supplied computing resource usage trajectories. The above features may have the technical effect of generating an oversubscription policy that more closely reflects policies generated by human experts.

According to this aspect, the imitation learning may be implemented at least in part with a behavior cloning term included in the objective function. The above feature may have the technical effect of generating an oversubscription policy that more closely reflects policies generated by human experts.

According to this aspect, the imitation learning may be implemented at least in part with an adversarial imitation learning term included in the objective function. The above feature may have the technical effect of generating an oversubscription policy that more closely reflects policies generated by human experts.

According to this aspect, the oversubscription reinforcement learner may include a trajectory encoder that receives the plurality of computing resource usage trajectories generates a plurality of trajectory embedding vectors corresponding to the computing resource usage trajectories. The above features may have the technical effect of converting the computing resource usage trajectories into a form in which they may be more easily processed at the oversubscription reinforcement learner.

According to this aspect, the objective function includes a representative capacity term proportional to a sum of distances between the plurality of prototypes and respective closest trajectory embedding vectors to those prototypes. The above features may have the technical effect of training the oversubscription reinforcement learner to generate prototypes that accurately model the computing resource usage trajectories used as training data.

According to this aspect, the one or more processing devices group the plurality of trajectory embedding vectors into a plurality of trajectory clusters corresponding to the plurality of prototypes. The objective function may include an interpretability term proportional to a sum of distances between the plurality of prototypes and respective closest trajectory embedding vectors within the corresponding trajectory clusters associated with those prototypes. The above features may have the technical effect of training the oversubscription reinforcement learner to generate human-interpretable prototypes.

According to this aspect, the one or more processing devices may output the prototype feedback query in response to determining that a cluster entropy of the trajectory cluster associated with the prototype is greater than a predefined uncertainty threshold or determining that an average distance between the prototype and the trajectory embedding vectors included in the trajectory cluster associated with the prototype is included in a predetermined number of highest average distances among the plurality of prototypes. The above features may have the technical effect of selectively soliciting human feedback related to the prototypes.

According to this aspect, the objective function may include a diversity term proportional to a sum of maximum distances between pairs of the prototypes. The above feature may have the technical effect of training the oversubscription reinforcement learner to generate prototypes that model a wider range of potential inputs.

According to this aspect, the prototype feedback input may be an approval input, a disapproval input, a merge input, a split input, or an update input. The above features may have the technical effect of allowing the human in the loop to provide a variety of different types of prototype feedback input.

According to this aspect, the prototype feedback input may be a merge input. In response to receiving the prototype feedback input, the one or more processing devices may generate a merged prototype based at least in part on the prototype and an additional prototype. The above features may have the technical effect of allowing the human in the loop to merge prototypes when the human in the loop determines that the prototypes are sufficiently similar to each other.

According to this aspect, the prototype feedback input may be a split input. In response to receiving the prototype feedback input, the one or more processing devices may generate a first split prototype and a second split prototype based at least in part on the prototype. The above features may have the technical effect of allowing the human in the loop to split a prototype when the human in the loop determines that the prototype models multiple distinct categories of trajectories.

According to this aspect, when computing the objective function value, the one or more processing devices may apply a respective plurality of scaling factors to a plurality of terms of the objective function based at least in part on the prototype feedback input and/or the oversubscription rate feedback input. The above features may have the technical effect of incorporating the human feedback into the computation of the value of the objective function.

According to another aspect of the present disclosure, a method is provided for use with an oversubscription reinforcement learner executed at a computing system. The method includes receiving a plurality of computing resource usage trajectories. At the oversubscription reinforcement learner, the method further includes generating a plurality of prototypes that encode respective prototype trajectories based at least in part on the plurality of computing resource usage trajectories. The method further includes, based at least in part on the plurality of prototypes, generating an oversubscription rate. The method further includes outputting, to a user interface, a prototype feedback query associated with a prototype of the plurality of prototypes and/or an oversubscription rate feedback query that indicates the oversubscription rate. The method further includes receiving a prototype feedback input via the user interface in response to outputting the prototype feedback query and/or receiving an oversubscription rate feedback input via the user interface in response to outputting the oversubscription rate feedback query. Based at least in part on the plurality of computing resource usage trajectories, the plurality of prototypes, and the prototype feedback input and/or the oversubscription rate feedback input, the method further includes computing an objective function value. The method further includes training the oversubscription reinforcement learner based at least in part on the objective function value. The above features may have the technical effect of allocating computing resources efficiently via oversubscription while avoiding overloading. In addition, the oversubscription reinforcement learner may generate the oversubscription rate in a human-interpretable manner.

According to this aspect, during an inferencing phase, the method may further include receiving inferencing-time computing resource usage data. Based at least in part on the inferencing-time computing resource usage data, the method may further include setting an inferencing-time oversubscription rate at the oversubscription reinforcement learner. The method may further include allocating computing resources to a plurality of virtual machines as specified by the inferencing-time oversubscription rate.

According to this aspect, the method may further include receiving one or more user-supplied computing resource usage trajectories via the user interface. The method may further include performing imitation learning of the plurality of prototypes based at least in part on the one or more user-supplied computing resource usage trajectories. The above features may have the technical effect of generating an oversubscription policy that more closely reflects policies generated by human experts.

According to this aspect, the method may further include, at a trajectory encoder included in the oversubscription reinforcement learner, receiving the plurality of computing resource usage trajectories. The method may further include generating a plurality of trajectory embedding vectors corresponding to the computing resource usage trajectories. The above features may have the technical effect of converting the computing resource usage trajectories into a form in which they may be more easily processed at the oversubscription reinforcement learner.

According to this aspect, the prototype feedback input may be an approval input, a disapproval input, a merge input, a split input, or an update input. The above features may have the technical effect of allowing the human in the loop to provide a variety of different types of prototype feedback input.

According to another aspect of the present disclosure, a computing system is provided, including one or more processing devices that, during a training phase, train an oversubscription reinforcement learner at least in part by receiving a plurality of computing resource usage trajectories. Training the oversubscription reinforcement learner further includes receiving one or more user-supplied computing resource usage trajectories via the user interface. Training the oversubscription reinforcement learner further includes, at a trajectory encoder, receiving the plurality of computing resource usage trajectories and generating a plurality of trajectory embedding vectors corresponding to the computing resource usage trajectories. Training the oversubscription reinforcement learner further includes generating a plurality of prototypes that encode respective prototype trajectories based at least in part on the plurality of computing resource usage trajectories. Training the oversubscription reinforcement learner further includes grouping the plurality of trajectory embedding vectors into a plurality of trajectory clusters corresponding to the plurality of prototypes. Based at least in part on the plurality of prototypes, training the oversubscription reinforcement learner further includes generating an oversubscription rate. Training the oversubscription reinforcement learner further includes computing an objective function value of an objective function that includes a representative capacity term proportional to a sum of distances between the plurality of prototypes and respective closest trajectory embedding vectors to those prototypes. The objective function further includes an interpretability term proportional to a sum of distances between the plurality of prototypes and respective closest trajectory embedding vectors within the corresponding trajectory clusters associated with those prototypes. The objective function further includes a diversity term proportional to a sum of maximum distances between pairs of the prototypes. The objective function further includes one or more imitation learning terms computed based at least in part on the one or more user-supplied computing resource usage trajectories. The oversubscription reinforcement learner is trained based at least in part on the objective function value.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices that, during a training phase, train an oversubscription reinforcement learner at least in part by:
receiving a plurality of computing resource usage trajectories;
at the oversubscription reinforcement learner, generating a plurality of prototypes that encode respective prototype trajectories based at least in part on the plurality of computing resource usage trajectories;
based at least in part on the plurality of prototypes, generating an oversubscription rate;
outputting, to a user interface:
a prototype feedback query associated with a prototype of the plurality of prototypes; and/or
an oversubscription rate feedback query that indicates the oversubscription rate;
receiving a prototype feedback input via the user interface in response to outputting the prototype feedback query, and/or receiving an oversubscription rate feedback input via the user interface in response to outputting the oversubscription rate feedback query;
based at least in part on the plurality of computing resource usage trajectories, the plurality of prototypes, and the prototype feedback input and/or the oversubscription rate feedback input, computing an objective function value; and
training the oversubscription reinforcement learner based at least in part on the objective function value.

2. The computing system of claim 1, wherein, during an inferencing phase, the one or more processing devices further:
receive inferencing-time computing resource usage data;
based at least in part on the inferencing-time computing resource usage data, set an inferencing-time oversubscription rate at the oversubscription reinforcement learner; and
allocate computing resources to a plurality of virtual machines as specified by the inferencing-time oversubscription rate.

3. The computing system of claim 1, wherein training the oversubscription reinforcement learner further includes:
receiving one or more user-supplied computing resource usage trajectories via the user interface; and
performing imitation learning of the plurality of prototypes based at least in part on the one or more user-supplied computing resource usage trajectories.

4. The computing system of claim 3, wherein the imitation learning is implemented at least in part with a behavior cloning term included in the objective function.

5. The computing system of claim 3, wherein the imitation learning is implemented at least in part with an adversarial imitation learning term included in the objective function.

6. The computing system of claim 1, wherein the oversubscription reinforcement learner includes a trajectory encoder that:
receives the plurality of computing resource usage trajectories; and
generates a plurality of trajectory embedding vectors corresponding to the computing resource usage trajectories.

7. The computing system of claim 6, wherein the objective function includes a representative capacity term proportional to a sum of distances between the plurality of prototypes and respective closest trajectory embedding vectors to those prototypes.

8. The computing system of claim 6, wherein:
the one or more processing devices group the plurality of trajectory embedding vectors into a plurality of trajectory clusters corresponding to the plurality of prototypes; and
the objective function includes an interpretability term proportional to a sum of distances between the plurality of prototypes and respective closest trajectory embedding vectors within the corresponding trajectory clusters associated with those prototypes.

9. The computing system of claim 8, wherein the one or more processing devices output the prototype feedback query in response to:
determining that a cluster entropy of the trajectory cluster associated with the prototype is greater than a predefined uncertainty threshold; or
determining that an average distance between the prototype and the trajectory embedding vectors included in the trajectory cluster associated with the prototype is included in a predetermined number of highest average distances among the plurality of prototypes.

10. The computing system of claim 1, wherein the objective function includes a diversity term proportional to a sum of maximum distances between pairs of the prototypes.

11. The computing system of claim 1, wherein the prototype feedback input is an approval input, a disapproval input, a merge input, a split input, or an update input.

12. The computing system of claim 1, wherein:
the prototype feedback input is a merge input; and
in response to receiving the prototype feedback input, the one or more processing devices generate a merged prototype based at least in part on the prototype and an additional prototype.

13. The computing system of claim 1, wherein:
the prototype feedback input is a split input; and
in response to receiving the prototype feedback input, the one or more processing devices generate a first split prototype and a second split prototype based at least in part on the prototype.

14. The computing system of claim 1, wherein, when computing the objective function value, the one or more processing devices apply a respective plurality of scaling factors to a plurality of terms of the objective function based at least in part on the prototype feedback input and/or the oversubscription rate feedback input.

15. A method for use with an oversubscription reinforcement learner executed at a computing system, the method comprising:
receiving a plurality of computing resource usage trajectories;
at the oversubscription reinforcement learner, generating a plurality of prototypes that encode respective prototype trajectories based at least in part on the plurality of computing resource usage trajectories;
based at least in part on the plurality of prototypes, generating an oversubscription rate;
outputting, to a user interface:
a prototype feedback query associated with a prototype of the plurality of prototypes; and/or
an oversubscription rate feedback query that indicates the oversubscription rate;
receiving a prototype feedback input via the user interface in response to outputting the prototype feedback query, and/or receiving an oversubscription rate feedback input via the user interface in response to outputting the oversubscription rate feedback query;
based at least in part on the plurality of computing resource usage trajectories, the plurality of prototypes, and the prototype feedback input and/or the oversubscription rate feedback input, computing an objective function value; and
training the oversubscription reinforcement learner based at least in part on the objective function value.

16. The method of claim 15, further comprising, during an inferencing phase:
receiving inferencing-time computing resource usage data;
based at least in part on the inferencing-time computing resource usage data, setting an inferencing-time oversubscription rate at the oversubscription reinforcement learner; and
allocating computing resources to a plurality of virtual machines as specified by the inferencing-time oversubscription rate.

17. The method of claim 15, further comprising:
receiving one or more user-supplied computing resource usage trajectories via the user interface; and
performing imitation learning of the plurality of prototypes based at least in part on the one or more user-supplied computing resource usage trajectories.

18. The method of claim 15, further comprising, at a trajectory encoder included in the oversubscription reinforcement learner:
receiving the plurality of computing resource usage trajectories; and
generating a plurality of trajectory embedding vectors corresponding to the computing resource usage trajectories.

19. The method of claim 15, wherein the prototype feedback input is an approval input, a disapproval input, a merge input, a split input, or an update input.

20. A computing system comprising:
one or more processing devices that, during a training phase, train an oversubscription reinforcement learner at least in part by:
receiving a plurality of computing resource usage trajectories;
receiving one or more user-supplied computing resource usage trajectories via the user interface;
at a trajectory encoder:
receiving the plurality of computing resource usage trajectories; and
generating a plurality of trajectory embedding vectors corresponding to the computing resource usage trajectories;
generating a plurality of prototypes that encode respective prototype trajectories based at least in part on the plurality of computing resource usage trajectories;
grouping the plurality of trajectory embedding vectors into a plurality of trajectory clusters corresponding to the plurality of prototypes;
based at least in part on the plurality of prototypes, generating an oversubscription rate;
computing an objective function value of an objective function that includes:
a representative capacity term proportional to a sum of distances between the plurality of prototypes and respective closest trajectory embedding vectors to those prototypes;
an interpretability term proportional to a sum of distances between the plurality of prototypes and respective closest trajectory embedding vectors within the corresponding trajectory clusters associated with those prototypes;
a diversity term proportional to a sum of maximum distances between pairs of the prototypes; and
one or more imitation learning terms computed based at least in part on the one or more user-supplied computing resource usage trajectories; and
training the oversubscription reinforcement learner based at least in part on the objective function value.
